(19) United States
(12) Patent Application Publication
(10) Pub. No.: US 2025/0280256 A1
(43) Pub. Date: Sep. 4, 2025

(54) METHODS AND SYSTEMS FOR MANAGING USER LOCATION USING A VIRTUAL SOUND SOURCE

(71) Applicant: Adeia Guides Inc., San Jose, CA (US)

(72) Inventors: Zhiyun Li, Kenmore, WA (US); Reda Harb, Saint Petersburg, FL (US)

(21) Appl. No.: 19/048,333

(22) Filed: Feb. 7, 2025

Related U.S. Application Data
(60) Provisional application No. 63/552,761, filed on Feb. 13, 2024.

(51) Int. Cl. H04S 7/00

(52) U.S. Cl. CPC H04S 7/303; H04S 2400/11

(57) ABSTRACT

System and methods are provided relating to managing user location using a virtual sound source. The presence of a first user within a local area network is detected. A visit session in response to detecting the presence of the first user is initiated. A location of the first user within the local area network during the visit session is determined. An output of one or more speakers to generate a virtual sound source at a remote location within the local area network away from the location of the first user is modified.

### CROSS-REFERENCE TO RELATED APPLICATION

This application claims the benefit of U.S. Provisional Patent Application No. 63/552,761, filed Feb. 13, 2024, which is hereby incorporated by reference herein in its entirety.

### BACKGROUND

The present disclosure relates to methods and systems for managing user location using a virtual sound source. Particularly, but not exclusively, the present disclosure relates to methods and systems for generating a virtual sound source at a location remote from a user location.

### SUMMARY

In the context of environments having a local area network, such as offices, malls and entertainment venues, it is desirable to manage a location of an individual within that network. For example, an individual may be required to attend a location remote from their current location, e.g., based on an activity, event or incident occurring at the remote location. In another scenario, an individual may desire to be guided to another location than their current location, such as a location of a friend or an amenity. And in some cases, it is desirable to help manage the density of crowds within a public environment, e.g., by diverting an individual towards or away from a certain location in the public environment. In one approach, a notification may be provided to a user instructing the user to move to a different location, e.g., by virtue of issuing a notification to a user device such as a smartphone or other signage. However, such an approach requires the user to interact with a user device or have sight of the signage. In another approach, a speaker system may broadcast an announcement to one or more individuals in an environment. However, such an approach is indiscriminate to the current location of an individual in the networked area and may interrupt other individuals to which the announcement is not directed.

The present disclosure provides improved systems and methods for assisting in the control of a user location within a local area network. For example, the systems and methods disclosed herein present a means for providing, e.g., in a dynamic manner, a contextualized and/or private notification to a user during a particular period in which a user interacts with at least one device connected to the local area network. For example, one or more virtual sound sources may be generated for providing information to a user based on a determined activity of the user, and/or the activities of other users, occurring during the interaction period.

According to aspects of the present disclosure, systems and methods are provided for managing user location using a virtual sound source. The presence of a first user within a local area network is detected, e.g., by virtue of interaction with a device connected to the local area network, using a facial recognition system, a presence of a user device on the network, etc. A visit session is initiated in response to detecting the presence of the first user within the network. A location of the first user within the local area network during the visit session is determined. An output of one or more speakers is modified to generate a virtual sound source at a remote location within the local area network away from the location of the first user. In some examples, the output of one or more speakers is modified to generate a virtual sound source in response to a user command issued during the visit session.

In some examples, the presence of a second user within the local network area during the visit session is detected. The second user may be associated with the visit session. A location of the second user may be determined within the local area network during the visit session. In some examples, the location of the second user corresponds to the remote location at which the virtual sound source is generated. In one embodiment, determining the location of any user can be approximate and in relationship to a known landmark within the venue (e.g., water fountain in the building, etc.).

In some examples, a first user device associated with the first user is assigned to (e.g., associated with) the visit session. In some examples, the location of the first user is based on the location of the first user device. In some examples, a second user device associated with the second user is assigned to (e.g., associated with) the visit session. In some examples, the location of the second user is based on the location of the second user device.

In some examples, a density of individuals at the location of the first user is determined. In some examples, the output of a speaker is modified to generate the virtual sound source at the remote location when the density of individuals associated with the location of the first user is greater than a predetermined density value. In some examples, the output of a speaker is modified to generate the virtual sound source at the remote location when the density of individuals associated with the location of the first user is less than a predetermined density value.

In some examples, a density of individuals at the remote location is determined. In some examples, the output of a speaker is modified to generate the virtual sound source at the remote location when the density of individuals associated with the remote location is less than a predetermined density value. In some examples, the output of a speaker is modified to generate the virtual sound source at the remote location when the density of individuals associated with the remote location is greater than a predetermined density value.

In some examples, a user profile, e.g., a user profile of the first user, is associated with the visit session. A setting in the user profile may be accessed, e.g., in response to detecting the presence of the first user within the local area network, or in response to the initiation of the visit session. In some examples, a first sound type is generated at the virtual sound source based on the setting in the user profile. In some examples, a user reaction to multiple sound types is determined. A setting in the user profile may be updated based on the user reaction.

In some examples, a first sound type is generated at a first sound source on, or connected to, the local area network during the visit session. The first sound source may be a physical sound source or a virtual sound source. In some examples, a second sound type is generated at a second sound source on, or connected to, the local area network during the visit session. The second sound source may be a physical sound source or a virtual sound source. A user reaction to each of the first and second sound sources may be determined.

In some examples, the one or more speakers generating the virtual sound source are located at a first user terminal on the local area network. In some examples, the location of the first user is based on the location of the first user terminal. In some examples, the remote location corresponds to a location of a second user terminal on the local area network.

In some examples, the first user terminal comprises a speaker array. In some examples, an outcome of an event at the first user terminal is determined. Based on the outcome of the event, a moving virtual sound source may be generated by modifying, in turn, an output of each of the speakers in the array to generate the virtual sound source.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an overview of a system for managing user location using a virtual sound source, in accordance with some examples of the disclosure;

FIG. 2 is a block diagram showing components of an example system for managing user location using a virtual sound source, in accordance with some examples of the disclosure;

FIG. 3 is a flowchart representing a process for managing user location using a virtual sound source, in accordance with some examples of the disclosure;

FIG. 4 illustrates an overview of a system for guiding a user to a location of another user using a virtual sound source, in accordance with some examples of the disclosure;

FIG. 5 is a flowchart representing a process for guiding a user to a location of another user using a virtual sound source, in accordance with some examples of the disclosure;

FIG. 6 illustrates an overview of a system for controlling crowd density using a virtual sound source, in accordance with some examples of the disclosure;

FIG. 7 is a flowchart representing a process for controlling crowd density using a virtual sound source, in accordance with some examples of the disclosure;

FIG. 8 is a flowchart representing a process for controlling user location using a virtual sound source corresponding to a predetermined sound type, in accordance with some examples of the disclosure;

FIG. 9 illustrates an overview of a system for determining a sound type associated with user account, in accordance with some examples of the disclosure;

FIG. 10 illustrates an overview of a system for generating a predetermined sound type at a remote location using a virtual sound source, in accordance with some examples of the disclosure;

FIGS. 11A and 11B illustrate an overview of a system for generating a moving virtual sound source, in accordance with some examples of the disclosure.

### DETAILED DESCRIPTION

Systems and methods are provided herein for managing user location using a virtual sound source. In the context of the present disclosure, a virtual sound source is a sound source that appears to originate from a desired location in space, e.g., away from a location at which the sound source is heard. For example, the output from multiple physical sound sources, e.g., speakers, can be used to generate a virtual sound source that a user can identify as occurring at an apparent origin in direction and distance from the user, using sound localization mechanisms.

There are many means to generate a virtual sound source. For example, wave field synthesis (WFS), based on the Huygens-Fresnel principle, and higher order ambisonics (HOA) are good examples of techniques that can be used to generate a virtual sound source. The systems and method disclosed herein generate a virtual sound source using multiple speakers that are spatially distributed in the vicinity of a user, e.g., at respective locations around a room, and/or using a speaker array, e.g., provided as part of a user terminal at which a user is situated. However, where technically possible, any appropriate system and method may be used to generate the virtual sound source as described herein, and the present disclosure is not limited to the exemplary methods and systems for generating the virtual sound source used in the below examples.

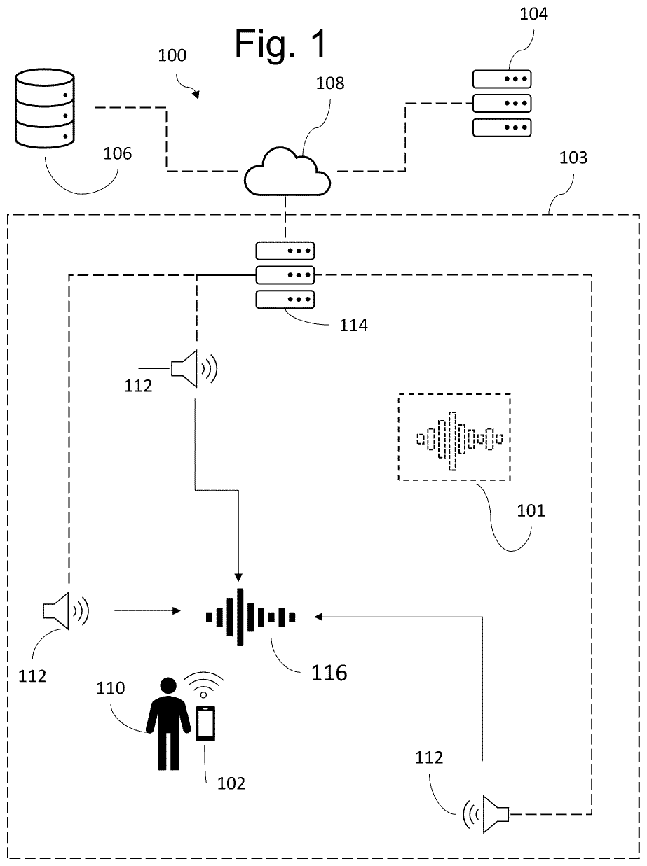

FIG. 1 shows a system 100 for managing user location using a virtual sound source 101. In the example shown in FIG. 1, user 110 is within a local area network (LAN), which is represented by dashed box 103. In the example shown in FIG. 1, the LAN is communicatively coupled with server 104 and database 106 by virtue of network 108. In the context of the present disclosure, a LAN is understood to be a computer network that interconnects devices within a limited area, such as an office block, a medical facility, a mall, or an entertainment venue, like a theme park or casino. For example, the LAN shown in FIG. 1 may be a network connecting multiple speakers 112 to server 114 (which in some examples may be the same server as server 104, a part of server 104, or a separate server), which is configured to control the output from each of the speakers 112, e.g., based on the location of user 110 and/or user device 102 within the LAN. The server 114 may in some examples be a controller, or comprise a customization function, which is configured to control aspects of the LAN such as the speakers 112 of this example. In some examples, user device 102 may be a user terminal, such as a workstation, a TV, or games machine, or a mobile device, such as a laptop or smart phone.

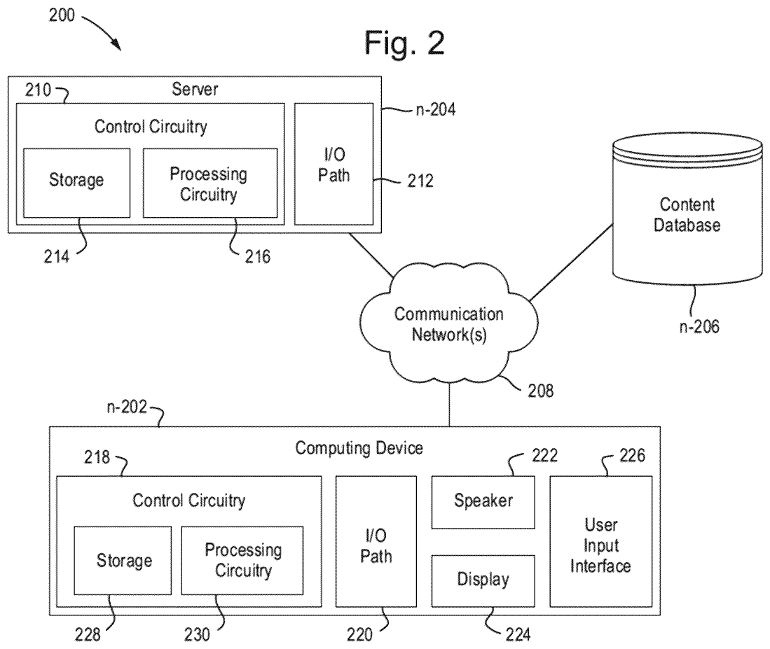

FIG. 2 is an illustrative block diagram showing example system 200, e.g., a non-transitory computer-readable medium, configured to manage user location using a virtual sound source. Although FIG. 2 shows system 200 as including a number and configuration of individual components, in some examples, any number of the components of system 200 may be combined and/or integrated as one device, e.g., as user device 102. System 200 includes computing device n-202 (denoting any appropriate number of computing devices, such as user device 102), server n-204 (denoting any appropriate number of servers, such as server 104), and one or more content databases n-206 (denoting any appropriate number of content databases, such as content database 106), each of which is communicatively coupled to communication network 208, which may be the Internet or any other suitable network or group of networks, such as network 108. In some examples, system 200 excludes server n-204, and functionality that would otherwise be implemented by server n-204 is instead implemented by other components of system 200, such as computing device n-202. For example, computing device n-202 may implement some or all of the functionality of server n-204, allowing computing device n-202 to communicate directly with content database n-206. In still other examples, server n-204 works in conjunction with computing device n-202 to implement certain functionality described herein in a distributed or cooperative manner.

Server n-204 includes control circuitry 210 and input/output (hereinafter “I/O”) path 212, and control circuitry 210 includes storage 214 and processing circuitry 216. Computing device n-202, which may be an HMD, a personal computer, a laptop computer, a tablet computer, a smartphone, a smart television, or any other type of computing device, includes control circuitry 218, I/O path 220, speaker 222, display 224, and user input interface 226. Control circuitry 218 includes storage 228 and processing circuitry 220. Control circuitry 210 and/or 218 may be based on any suitable processing circuitry such as processing circuitry 216 and/or 230. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 214, 228, and/or storages of other components of system 200 (e.g., storages of content database n-206, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 214, 228, and/or storages of other components of system 200 may be used to store various types of content, metadata, and or other types of data. Non-volatile memory may also be used (e.g., to launch a boot-up routine and other instructions). Cloud-based storage may be used to supplement storages 214, 228 or instead of storages 214, 228. In some examples, control circuitry 210 and/or 218 executes instructions for an application stored in memory (e.g., storage 214 and/or 228). Specifically, control circuitry 210 and/or 218 may be instructed by the application to perform the functions discussed herein. In some implementations, any action performed by control circuitry 210 and/or 218 may be based on instructions received from the application. For example, the application may be implemented as software or a set of executable instructions that may be stored in storage 214 and/or 228 and executed by control circuitry 210 and/or 218. In some examples, the application may be a client/server application where only a client application resides on computing device n-202, and a server application resides on server n-204.

The application may be implemented using any suitable architecture. For example, it may be a stand-alone application wholly implemented on computing device n-202. In such an approach, instructions for the application are stored locally (e.g., in storage 228), and data for use by the application is downloaded on a periodic basis (e.g., from an out-of-band feed, from an Internet resource, or using another suitable approach). Control circuitry 218 may retrieve instructions for the application from storage 228 and process the instructions to perform the functionality described herein. Based on the processed instructions, control circuitry 218 may determine what action to perform when input is received from user input interface 226.

In client/server-based examples, control circuitry 218 may include communication circuitry suitable for communicating with an application server (e.g., server n-204) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 208). In another example of a client/server-based application, control circuitry 218 runs a web browser that interprets web pages provided by a remote server (e.g., server n-204). For example, the remote server may store the instructions for the application in a storage device. The remote server may process the stored instructions using circuitry (e.g., control circuitry 210) and/or generate displays. Computing device n-202 may receive the displays generated by the remote server and may display the content of the displays locally via display 224. This way, the processing of the instructions is performed remotely (e.g., by server n-204) while the resulting displays, such as the display windows described elsewhere herein, are provided locally on computing device n-202. Computing device n-202 may receive inputs from the user via input interface 226 and transmit those inputs to the remote server for processing and generating the corresponding displays.

A computing device n-202 may send instructions, e.g., to generate subtitles, to control circuitry 210 and/or 218 using user input interface 226. User input interface 226 may be any suitable user interface, such as a remote control, trackball, keypad, keyboard, touchscreen, touchpad, stylus input, joystick, voice recognition interface, gaming controller, or other user input interfaces. User input interface 226 may be integrated with or combined with display 224, which may be a monitor, a television, a liquid crystal display (LCD), an electronic ink display, or any other equipment suitable for displaying visual images.

Server n-204 and computing device n-202 may transmit and receive content and data via I/O path 212 and 220, respectively. For instance, I/O path 212, and/or I/O path 220 may include a communication port(s) configured to transmit and/or receive (for instance to and/or from content database n-206), via communication network 208, content item identifiers, content metadata, natural language queries, and/or other data. Control circuitry 210 and/or 218 may be used to send and receive commands, requests, and other suitable data using I/O paths 212 and/or 220.

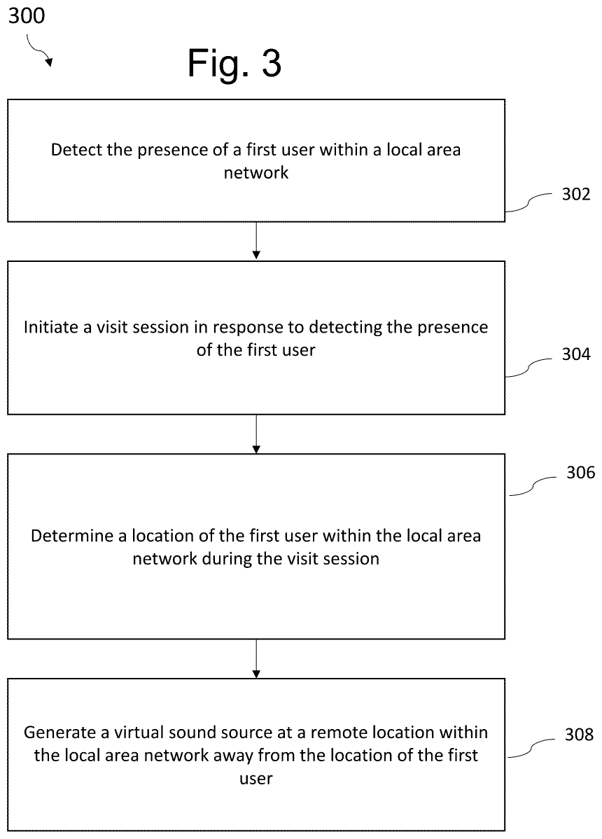

FIG. 3 shows a flowchart representing an illustrative process 300 for managing user location using a virtual sound source. While the example shown in FIG. 3 refers to the use of system 100, as shown in FIG. 1, it will be appreciated that the illustrative process 300 shown in FIG. 3 may be implemented, in whole or in part, on system 100, system 200, and/or any other appropriately configured system architecture. For the avoidance of doubt, the term “control circuitry” used in the below description applies broadly to the control circuitry outlined above with reference to FIG. 1 and/or FIG. 2. For example, control circuitry may comprise control circuitry of user device 102, control circuitry of server 104, and control circuitry of server 114, working either alone or in some combination.

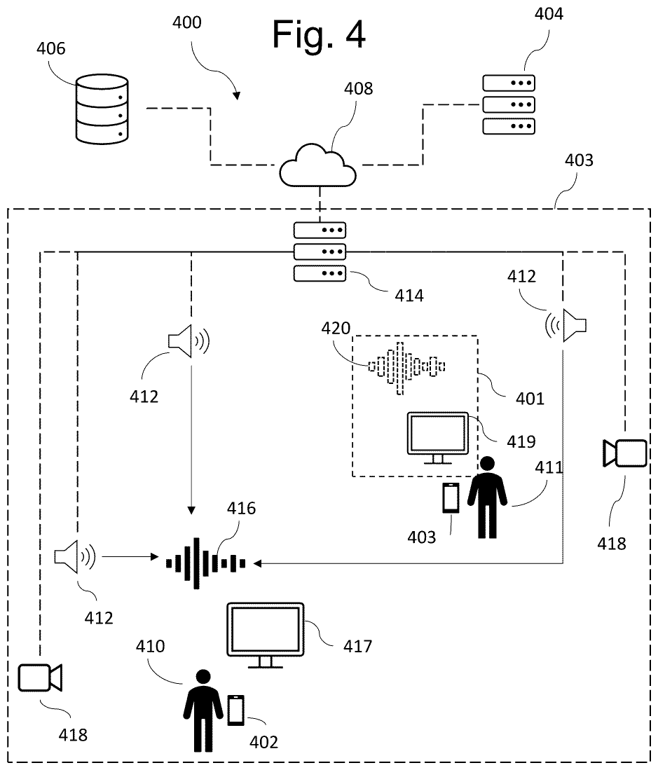

At 302, control circuitry, e.g., control circuitry of server 114, detects the presence of user 110 (e.g., a first user) within a LAN represented by box 103. In the example shown in FIG. 1, the presence of user 110 is based on the detection of a user device 102 operating within the LAN. For example, user device 102 may be associated with a user account. As such, control circuitry may infer the presence of user 110 with LAN based on communication between the user device 102 and server 114. For example, where the user device 102 is a smartphone, connection of the smartphone to the LAN, e.g., via Wi-Fi or Bluetooth, can result in detection and identification of user 110. In other examples, such as those shown in FIGS. 4, 6, 9, 10, 11A and 11B, the presence of user 110 within the LAN may be determined in one or more alternative way, such as by use of an ID card (physical or digital) interacting with a user terminal on the LAN, and/or by virtue of facial recognition systems. These examples are described below in more detail.

At 304, control circuitry, e.g., control circuitry of server 114, initiates a visit session in response to detecting the presence of the user 110. For example, control circuitry may log a time at which user 110 enters the LAN or the venue associated with the LAN, and a time at which user leaves the LAN, thereby establishing a period of LAN access or interaction with the LAN. In some examples, a visit session may extend over multiple, separate interactions with the LAN. For example, a user may access the LAN for multiple periods on the same day or over separate days. The initial creation of a visit session allows for activity of user 110 to be tracked and/or one or more user preferences to be implemented on the LAN over the periods of access. In some examples, the visit session may be used to manage one or more parameters associated with the user's operation of devices on the LAN. For example, initiation of the visit session may cause the location of user 110 to be monitored while within the LAN. Monitoring of the user's location may be performed using similar methods for detecting the initial presence. For example, a user's location may be monitored based on the location and/or operation of user device 102 on the LAN. Further benefits of initiating a visit session will be apparent with reference to the system of FIG. 4, e.g., where multiple users are present within the LAN at the same time (where these users may be associated with one another). This is described later in further detail.

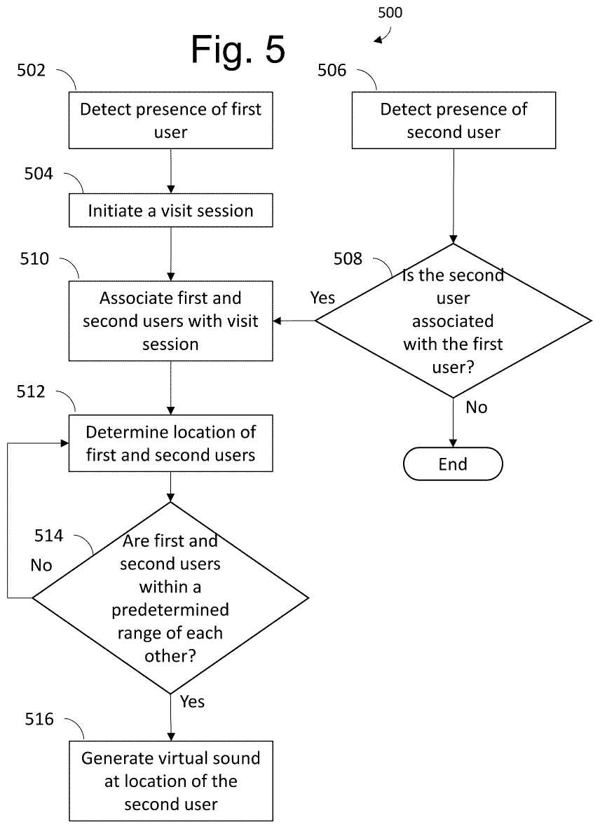

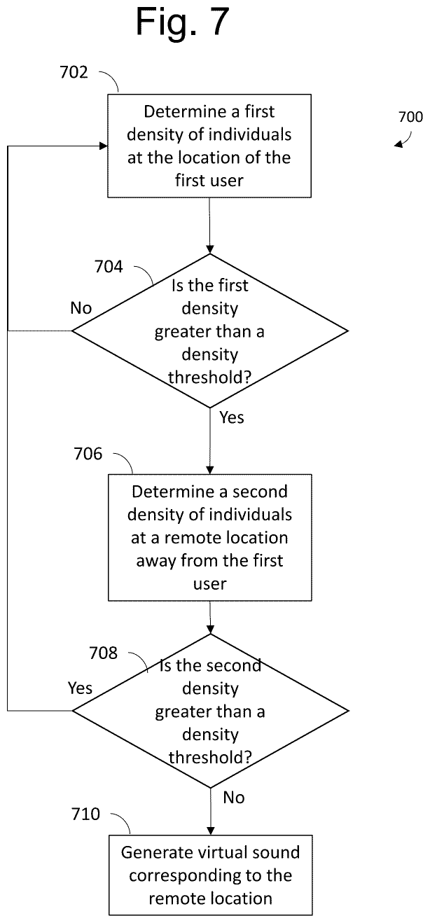

At 306, control circuitry, e.g., control circuitry of server 114 and/or server 104, determines a location of user 110 within the LAN. The user's location may be determined based in various ways. For example, where the user's activity within the LAN is being tracked, the location of the user may be inferred based on the activity. For example, a user's activity may involve user 110 interacting with one or more user devices 102 connected to the LAN (e.g., a user device such as a mobile phone, or a user terminal such as a gaming device), wherein the location of the user 110 is inferred from the location of the user device 102 connected to the LAN. In some examples, where the user device 102 is a smartphone, the user's location may be determined based on location data received from the smartphone at server 114. In some examples, a camera system may be used to determine the location of user 110 within the LAN. For example, in response to initiating the visit session at 304, control circuitry may activate a camera-based tracking system to monitor and determine the location of user 110 during the visit session, e.g., only while the user 110 is within the LAN. For example, when the user 110 leaves or ceases to access the LAN, the location determination and/or monitoring may cease. The determination of the user location is described below in further detail, e.g., in relation to the systems shown in FIGS. 5 and 7.

At 308, control circuitry, e.g., control circuitry of server 114 and/or server 104, modifies an output of one or more speakers 112 to generate a virtual sound source 101 at a remote location within the LAN away from the location of the user 110. The virtual sound source 101 may be generated by generating in the proximity of the user 110 (e.g., at a first location) a sound 116 which appears to the user 110 to have been generated at or originated from a location remote from the user 110 (e.g., at a second location), e.g., at the virtual sound source 101. For example, the sound 116 may appear to the user 110 to originate from the virtual sound source 101. The location of the sound 116 as perceived by the user 110 is indicated herein using a dashed copy of the sound 116, which is shown as being located at the virtual sound source 101, rather than a location proximate to the user 110. The goal of generating the virtual sound source 101 at a remote location away from the location of the user 110 is to cause the attention of the user to be drawn towards the remote location. For example, the remote location may be a location within the LAN that an operator of the LAN prefers user 110 to move towards. For example, it may be beneficial to indicate to user 110 a location of an event or activity at a location within the LAN (e.g., it may be determined after the user is identified that the user has a reservation at a restaurant within the venue and the generation of the virtual sound source may be used to guide the user to location or vicinity of the restaurant). The systems and methods provided herein can provide such an indication to user 110 without user 110 having to interact with or operate a user device 102. Advantageously, the sound 116 generated proximate to the user may be directional (e.g., directed towards the user by beamforming processes and the like), such that the sound 116 may not be audible to other individuals. Thus, other individuals may not be disturbed by the sound generated in the vicinity of the user.

As is described above, a virtual sound source 101 may be generated. The sound 116 generated may appear to originate from a target location (e.g., at the virtual sound source 101), where in reality, the sound 116 may be generated by a speaker array (e.g., a speaker array at a user terminal) with speakers remote from the target location, and in some examples, the sound 116 may be directed to the user (for example, using beamforming processes and the like). In order to generate the virtual sound source appearing to originate from a target location, a simulation may be performed to determine the sound that would be received at the speakers from which the sound will be generated (e.g., received at virtual microphones at the speakers) from a sound source (e.g., a simulated sound source) at the target location. The simulated received sound may then be played by the speaker array, where this sound may then appear to a user to originate from the target location.

According to the Huygens-Fresnel principle, in order to simulate the sound received at the speaker array, the distance d from the virtual sound source (e.g., the target location at which it the sound is to appear to originate from) and each speaker which will output the sound (e.g., the distance to a microphone at the speaker) is required. The distance d may therefore be determined based on the location of, for example, each speaker of a speaker array comprised in (e.g., part of) a user terminal, and the target location. The received sound may thus be simulated by considering a time-shift and attenuation of the sound from travelling that distance. Equation 1 outlines an example of the resultant time shifted attenuation H (t) at a speaker of the speaker array, where A is intensity (proportional to the square of the amplitude), t is time, and c is the speed of sound (e.g., approximately 340 m/s):

$$H ( t ) = \frac{A ( t - \frac{d}{c} )}{{d}^{2}} \qquad ( 1 )$$

The resultant sound may thus be played by the respective speaker for which it is calculated.

As is described above, it will be appreciated that this is one example of how the virtual sound source may be generated, and any appropriate system and method may be used to generate the virtual sound source as described herein, where the present disclosure is not limited to the exemplary methods and systems for generating the virtual sound source used in the examples herein.

The actions or descriptions of FIG. 3 may be performed in any suitable alternative orders or in parallel to further the purposes of this disclosure.

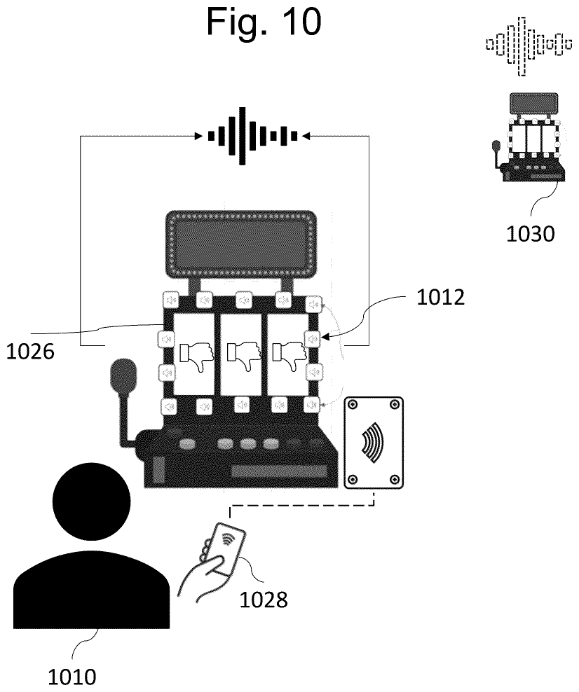

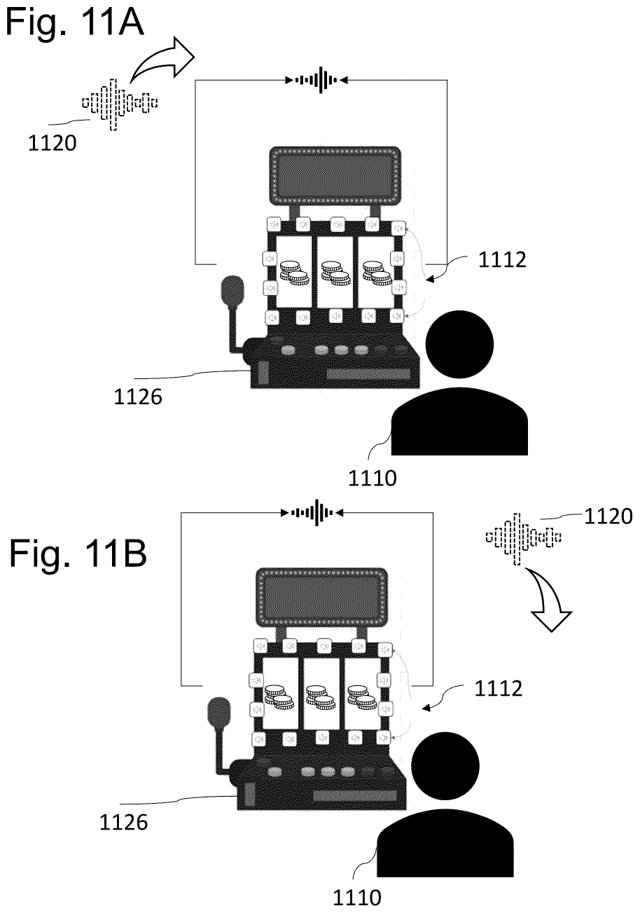

The below examples shown in FIGS. 4-11B illustrate various ways in which the general process 300 illustrated in FIG. 3 may be implemented. In particular, the below examples of FIGS. 10, 11A and 11B make reference to assisting in the management of a user's location in an entertainment venue, such as a casino. However, it is to be understood that the present disclosure is not limited to such an example, and general process 300 may be implemented in a variety of situations, such as in any appropriate venue or location where assistance in the control of peoples' locations is desired, such as in hotels, medical facilities, malls, office buildings, etc. In some cases, the systems and methods disclosed herein may be of use during an emergency situation, e.g., to divert the attention of one or more individuals to a selected location within the LAN associated with the venue. For example, diversion of peoples' attention may be desired to draw their interest away from an emergency event, e.g., a medical incident that is occurring within, or within the vicinity of the LAN. Such systems and methods may thus provide a more discrete process for diverting attention away from an incident.

FIG. 4 is an illustrative block diagram showing example system 400, e.g., a non-transitory computer-readable medium, configured to guide a user to a location of another user using a virtual sound source 401. In the example shown in FIG. 4, a first user 410 and a second user 411 are within a local area network (LAN), which is represented by dashed box 403. In the example of FIG. 4, the LAN 403 is communicatively coupled with server 404 and database 406 by virtue of network 408. The LAN 403 of FIG. 4 may be a network connecting multiple speakers 412 to server 414, which is configured to control the output of each of the speakers 412, e.g., based on the location of the first user 410 and/or based on the location of the second user 411 within the LAN. In the example shown in FIG. 4, the LAN 403 may be a network connecting multiple cameras 418 (e.g., video cameras) as part of a camera-based system, such as a camera based tracking system. For example, the cameras 418, as part of a tracking system, may be used to determine a current location of the first user 410 and the second user 411, e.g., via use of facial recognition. As is described above, a camera-based tracking system to track the movement of the user may be activated upon detection and identification of the user within the LAN, e.g., based on the connection of a user device, such as the first user device 402 or the second user device 403 to the LAN, e.g., via Wi-Fi or Bluetooth. In this example, the first user device 402 and/or the second user device 403 are mobile devices, such as a laptop, smart watch, or a smartphone, although it will be appreciated that a user device may instead be a user terminal, such as a TV, a gaming machine (e.g., slot machine with a fixed location within a venue such as a casino), or a computer terminal. For example, where a user is identified at a user terminal, e.g., by logging in with their credentials, or by using a card (e.g. inserting a physical card such as a loyalty card or using personal data such as a phone number or username/password to log-in) that identifies the user at the user terminal, the presence of the user within the LAN may be detected and/or the location of the user may be identified.

FIG. 5 shows a flowchart representing an illustrative process 500 for guiding a user to a location of another user using a virtual sound source. While the example shown in FIG. 5 refers to the use of system 400, as shown in FIG. 4, it will be appreciated that the illustrative process 500 shown in FIG. 5 may be implemented, in whole or in part, on system 100, system 200, system 400, and/or any other appropriately configured system architecture. For the avoidance of doubt, the term “control circuitry” used in the below description applies broadly to the control circuitry outlined above with reference to FIG. 1 and/or FIG. 2. For example, control circuitry may comprise control circuitry of user device 102 and control circuitry of server 104, working either alone or in some combination.

At 502, control circuitry, e.g., control circuitry of server 404 and/or server 414, detects the presence of a first user 410 within a LAN represented by box 403. In the example shown in FIG. 4, the detection of the presence of the first user 410 is based on the detection of a first user device 402 associated with the first user 410 operating within the LAN 403, as is described above in relation to FIG. 3. It will be appreciated that in the example shown in FIG. 4, the detection of the presence of the first user 410 may be performed using a camera 418 of the camera system, which may use processes such as facial recognition in order to identify a user and detect their presence within the venue (for example, where the user has attended the venue before). In some examples, the detection of the presence of the first user 410 may be performed by the user checking in to the venue or utilizing a user identifier card (e.g., a loyalty card) with a user terminal, such as a first user terminal 417 or a second user terminal 419.

At 504, control circuitry, e.g., control circuitry of server 404, initiates a visit session. For example, control circuitry may log a time at which the first user 410 enters a venue associated with LAN and a time at which user leaves the vicinity associated with the LAN, thereby establishing a period of LAN access or interaction with the LAN (e.g., based on the detection of the presence of the user within the LAN, such as based on the detection of the interaction of the user with a device connected to the LAN). As is described above, in some examples, a visit session may extend over multiple, separate interactions with the LAN. For example, a user may access the LAN for multiple periods on the same day or over separate days. The initial creation of a visit session allows for activity of user 410 to be tracked and/or one or more user preferences to be implemented on the LAN over the periods of access. A visit session may be associated with a profile of a user, where information regarding the visit session, such as a user's movement within the LAN during the visit session, may be stored in connection with the profile of the user. The profile of the user may be stored on a user device, such as a mobile device of the user, in a database connected to the LAN, or maybe associated with a loyalty card of the user. In some examples, the visit session may be used to manage one or more parameters associated with the user's operation of devices on the LAN. For example, initiation of the visit session may cause the location of the first user 410 to be monitored while within the LAN. Monitoring of the user's location may be performed using similar methods for detecting the initial presence. For example, a user's location may be monitored based on the location and/or operation of the first user device 402 on the LAN, and/or may be monitored using cameras 412 of a camera system which may be used to determine the user's location within the LAN. In some examples, the first user device 402 associated with the first user may be assigned to or associated with the visit session. In some examples, the use of a card attributed to the user, such as an ID card, or a loyalty card, may be used to identify the location of the user within the LAN, for example, where such a card is used in conjunction with a user terminal of known location. In some examples, a user device may be used to identify a user, where their facial characteristics may then be associated with their identity using the camera system, where the movement of the user may subsequently be tracked using facial recognition. In some examples, the user may initially be identified based on the first user device 402, or another method such as by the user checking in to the venue or utilizing a user identifier card (e.g., a loyalty card) with a user terminal, such as a first user terminal 417 or a second user terminal 419, where their identity may be associated with an image of their face (e.g., based on information provided by the first user device 402 or the ID card), and where their location within the LAN may subsequently be determined using a camera based tracking system in conjunction with facial recognition methods.

At 506, control circuitry, e.g., control circuitry of server 404 and/or server 414, detects the presence of a second user. For example, the presence of a second user within the local network area during the visit session is detected. The presence of the second user 411 may be detected in the same or similar manner as the way in which the presence of the first user 410 is detected as described above. For example, the presence of the second user 411 may be detected based on the detection of a second user device 403 associated with the second user 411 operating within the LAN, and/or may be detected based on facial recognition processes performed based on the feed of cameras 418 of the camera system, and/or may be detected based on the use of a card that identifies that user, and so on.

At 508, control circuitry, e.g., control circuitry of server 404 and/or server 414, determines whether the second user 411 is associated with the first user 410. The association may be based on respective user profiles, or user accounts, of the first user 410 and the second user 411. For example, the user profiles may indicate that the second user 411 may be a friend or relative of the first user, and/or may be part of a group which is visiting the venue comprising the LAN. In some examples, the first user 410 may be associated with the second user 411 based on their grouping within the venue. For example, where the first user 410 and second user 411 enter the venue together, it may be assumed that they are attending the venue together and are therefore acquainted with one another. Similarly, where the first user 410 and the second user 411 move through the venue together, or periodically return to one another, it may be assumed that the first and second users are acquainted with one another. In some examples, it may be determined that the first user 410 and the second user 411 are associated with one another, for example, based on social media accounts belonging to the respective users (e.g., are friends or follow one another on a social media platform). In some examples, it may be determined that the first user 410 and the second user 411 are associated with one another based on information related to a loyalty card. For example, a plurality of users may be associated with the same loyalty card profile, or may have associated loyalty card profiles, such as members of the same family, where each user may have their own individual loyalty card which is linked to the same loyalty card profile, or where their loyalty cards or loyalty card profiles are associated with one another. In some examples, the first user 410 may be associated with the second user 411 based on their belonging to the same group, such as working for the same company, being on the same tour group, and so on. Where the second user 411 is not associated with the first user 410 (e.g., NO at 508), the process ends.

Where the second user 411 is associated with the first user 410 (YES at 508), at 510, control circuitry, e.g., control circuitry of server 404, associates the first user 410 and the second user 411 with the visit session. A second user device 403 associated with the second user 411 may be assigned to the visit session, wherein the location of the second user 411 may be based on the location of the second user device 403. For example, a user device such as a mobile phone, or a loyalty card (which may be a virtual loyalty card, e.g., on a mobile device of the user), associated with a particular user may be attributed to the visit session. It may be beneficial to assign associated users to the same visit session in order to monitor and/or manage the location of groups of associated users within the LAN.

At 512, control circuitry, e.g., control circuitry of server 404, determines the location of the first user 410 and the second user 411. For example, the location of the second user 411 within the LAN 403 during the visit session may be determined, using e.g., a detected location of a user device of the user, using facial recognition, or based on an ID card associated with the user, such as a loyalty card. For example, the use of an ID card at a particular user terminal may indicate the presence of the user associated with the ID card at that user terminal. The location of the first user 410 and/or the second user 411 may be determined as described in relation to FIG. 3. In the example shown in FIG. 5, the location of the first user and/or the second user may be determined using a camera system, as is described above. For example, the camera system may be operable to identify a particular user, for example, using facial recognition, and then track the movement of that user within the LAN 403. Cameras 418 of the camera system may be located at different positions within the LAN 403 in order for the camera system to be able to visualize different areas of the LAN 403, thereby determining the location of the user within the LAN 403.

At 514, control circuitry, e.g., control circuitry of server 404, determines whether the first user 410 and the second user 411 are within a predetermined range of each other. For example, based on the determined location of each of the first user 410 and the second user 411, the relative distance between these users may be determined. This relative distance may then be used to determine whether the first user 410 and the second user 411 are within a predetermined range of one another. Where it is determined that the first user 410 and the second user 411 are not within a predetermined range of each other (NO at 514), the process moves back to 512.

Where it is determined that the first user 410 and the second user 411 are within a predetermined range of each other (YES at 514), at 516, control circuitry, e.g., control circuitry of server 414, generates a virtual sound 420 at a location of the second user 411. For example, this may be achieved by generating a sound 416 in the vicinity of the first user 410 which sounds as though it originates from location 401 of the second user 411, e.g., using the speakers 412. The sound 416 may be beamformed so as to be directed to the location of the first user 410. The location of the second user 411 may correspond to a remote location (e.g., a location different from the current location of the first user) at which the virtual sound 420 is generated. Thus, the first user 410 may hear the virtual sound 420 as a sound originating from the location of the second user 411. The first user 410 may be guided to the location of the second user 411 based on first user's understanding of the location or origin of the virtual sound 420.

In this example, only a first user 410 and a second user 411 are illustrated. However, it will be appreciated that any number of users may be associated with the same visit session. Furthermore, while this example illustrates the use of a virtual sound source 401 to guide associated users to one another, in other examples, the associated users may be encouraged by use of the virtual sound source to move into different locations from one another.

In some examples, the directing of the first user to the second user may be based on a request from the first user, for example, where the user requests, via a user device or the like, that the second user is located. In response to the request, a virtual sound source may be generated corresponding to the location of the second user, so that the first user is able to locate the second user. For example, where users are associated with the same visit session ID, an application on a mobile device may list the users associated with a particular visit session ID, where the first user may be able to determine the location of a user shown in the list by requesting the locating of the desired user (e.g., by selecting that user). Alternatively, or additionally, the location may be performed by the first user issuing a verbal command, such as “Find user 2”, which may be received by a microphone of a user terminal at which the current user is currently positioned. If the requested user is associated with the same visit session as the first user, the location of the requested user may be indicated by use of a virtual sound source. The list of users associated with a visit session ID is updated while the session lasts. For example, if one of the users associated with the visit session ID exits the vicinity, then the list is updated to reflect that. For example, the list might indicate the time the user device disconnected from the LAN. Additionally, determining that a user has existed the venue may be determined using the cameras 418. In other embodiments, users associated with a particular visit session may themselves indicate that they are leaving the venue using a designated application (e.g., application on the user device or application on a user terminal such as a slot machine), and may leave a message, such as a text-based or voice-based message to one or users in the party associated with the visit session ID.

In some examples, the sound may be a sound associated with the visit session, where the same sound may be utilized in respect of each user associated with the visit session.

The actions or descriptions of FIG. 5 may be performed in any suitable alternative orders or in parallel to further the purposes of this disclosure.

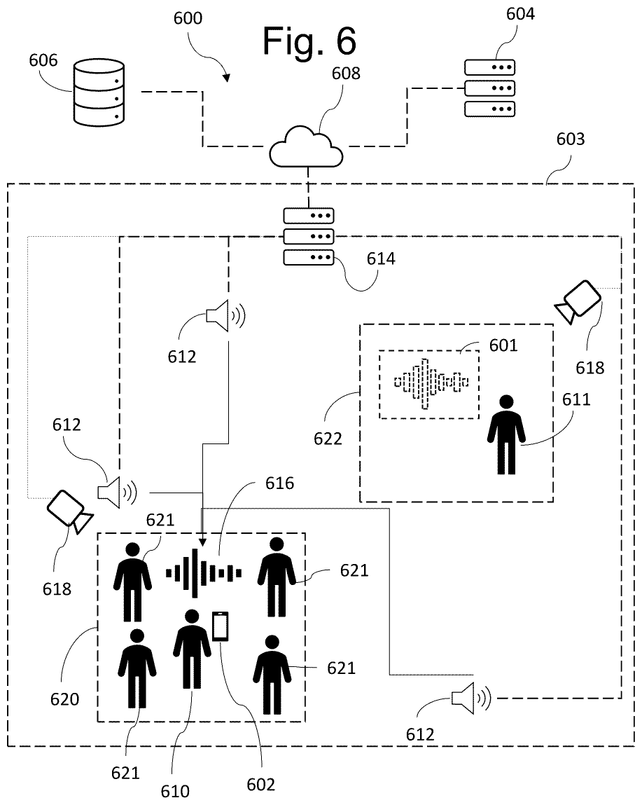

FIG. 6 is an illustrative block diagram showing example system 600, e.g., a non-transitory computer-readable medium, configured to control crowd density using a virtual sound source 601. In the example shown in FIG. 6, a first user 610 and a second user 611 are within a local area network (LAN), which is represented by dashed box 603. In the example of FIG. 6, the LAN is communicatively coupled with server 604 and database 606 by virtue of network 608. The LAN of FIG. 6 may be a network connecting multiple speakers 612 to server 614, which is configured to control the output of each of the speakers 612, e.g., based on the location of the first user 610 and based on the location of the second user 611. The LAN may be a network connecting multiple cameras 618 of a camera system to server 614, which is configured to control the cameras, such as by controlling the viewing direction of the camera, or the time at which video footage is collected. FIG. 7 shows a flowchart representing a process for controlling crowd density using a virtual sound source.

At 702, control circuitry, e.g., control circuitry of server 604, determines a first density of individuals 621 at the location of the first user 610. For example, the first density of individuals may be determined using at least one camera 618 of the camera system, where the camera system may observe the number of individuals within a particular area (e.g., a first area 620), or within a particular radius of the first user 610. For example, the first area may be defined based on a predetermined distance (e.g., radius) from the first user 610. In some examples, the area may be defined at least partly by the boundaries of a room in which the first user 610 is present. The area may be based on the distance between the first user 610 and the second user, for example, where the area is proportional to the distance between the first user 610 and the second user. The area may be defined considering obstacles in the vicinity of the first user 610. For example, the area may be defined as an area in which it is possible for an individual to occupy (e.g. an individual could not occupy the same space as a vending machine).

At 704, control circuitry, e.g., control circuitry of server 604, determines whether the first density is greater than a density threshold. For example, it may be determined whether the density is greater than a desired density of individuals within a particular area. This may be advantageous when considering safety concerns, where high density of individuals within particular areas may be considered to be unsafe. The density threshold may vary depending on the area in which the first user 610 is located.

Where the first density is not greater than the density threshold (NO at 704), the process moves back to 702. For example, where it is determined that the number of individuals within a particular area is sufficiently low, no action may be taken.

Where the first density is greater than the density threshold (YES at 704), at 706, control circuitry, e.g., control circuitry of server 604, determines a second density of individuals at a remote location away from the first user 610. For example, where it is determined that the number of individuals within a particular area is too high, it may be determined whether there is another area (e.g., a second area 622) to which individuals may be directed. The second area 622 may be an area proximate or surrounding a second user 611. The second area 622 may be defined based on a predetermined distance (e.g., radius) from the second user 611. In some examples, the area may be defined at least partly by the boundaries of a room in which the second user 611 is present. The area may be based on the distance between the first user 610 and the second user 611, for example, where the area is proportional to the distance between the first user 610 and the second user 611. The boundary of the area may be defined considering obstacles in the vicinity of the second user 610. For example, the area may be defined as an area in which it is possible for an individual to occupy.

At 708, control circuitry, e.g., control circuitry of server 604, determines whether the second density is greater than a density threshold (e.g., the same density threshold or a second density threshold). For example, it may be determined whether the second density is lower than the first density, and/or lower than a preset threshold. Where the second density is greater than the density threshold (YES at 708), the process moves back to 702.

Where the second density threshold is not greater than the density threshold (NO at 708), at 710, control circuitry, e.g., control circuitry of server 604, causes a virtual sound corresponding to (at) the remote location to be generated, for example, in the vicinity of the second user 611. For example, the output of at least one speaker 612 may be modified to generate a sound 616 in the vicinity of the first user 610 which sounds as though it originates from the virtual sound source corresponding to the remote location of the second user 622 when the density of individuals at the location of the first user is greater than a predetermined density value. This may encourage the first user 610 to move from a crowded area to a less crowded area.

In some examples, a virtual sound may be generated for each, or a plurality of, individuals 621, e.g., within the first area 620. For example, a sound 616 may be generated based on the location of an individual 621 relative to user 610, e.g., such that the desired location of the virtual sound source 601 appears to be the same for the user 610 and each individual 621 in area 620. In some examples, the sound 616 which is generated for the first user 610 may be modified based on a distance and/or a direction from the first user 610 to a particular individual 621, to generate a sound for that individual 621 which also corresponds to the location of the virtual sound source 601. Thus, a virtual sound 601 generated for an individual 621 may appear to the individual 621 to originate from the same location as the virtual sound 601 generated for the first user 610 and/or other individuals in area 620. In some examples, the sound 616 generated for individual 621 may be directed to that individual 621, e.g., by modifying a beam focused sound as a function of an offset between the user 610 and the individual 621. In this manner, user 610 and individual 621 may perceive a virtual sound source 601 of similar quality and at a similar location. This may be beneficial when it is desirable to encourage multiple persons within the same area to move to the same location, e.g., avoiding confusion as to the meaning of the virtual sound source 601.

In some examples, it may instead be determined that the first density is less than the density threshold, and the second density is greater than the density threshold (or another density threshold), in which case, the output of at least one speaker 612 may be modified to generate the virtual sound source at the remote location (e.g., proximate to the second user 611). Thus, a user may be encouraged to move to a particular location where more individuals are gathered, or simply to a different location, which may be advantageous, for example, in the event of an emergency where it is necessary for individuals to congregate in particular locations.

The actions or descriptions of FIG. 7 may be performed or executed in any suitable alternative orders or in parallel to further the purposes of this disclosure.

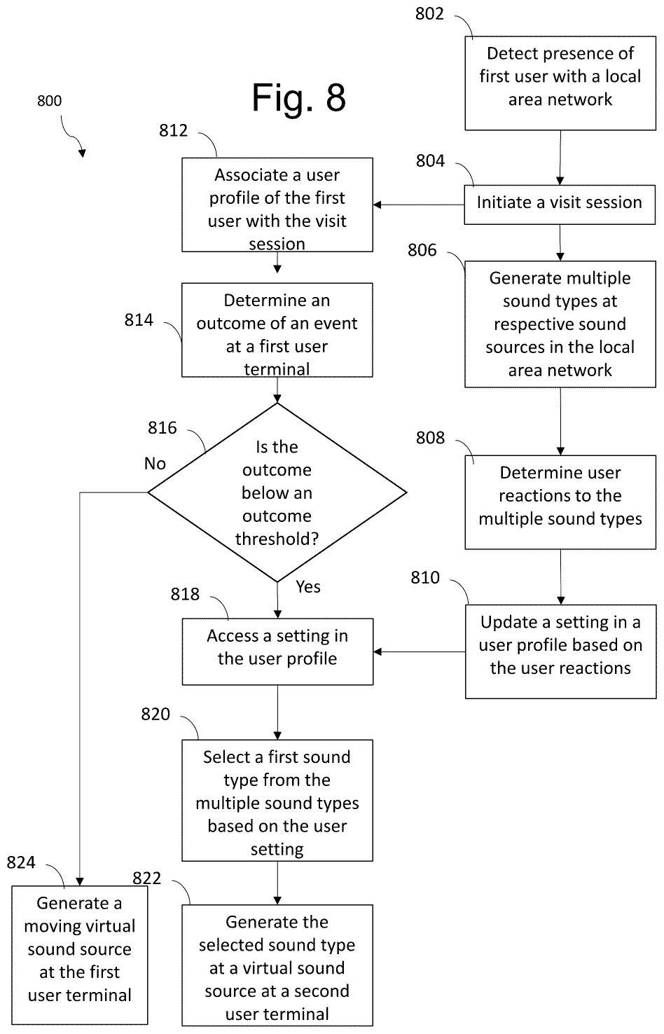

FIG. 8 shows a flowchart representing an illustrative process 800 for controlling user location using a virtual sound source corresponding to a predetermined sound type. While the example shown in FIG. 8 refers to the use of system 100, as shown in FIG. 1, it will be appreciated that the illustrative process 800 shown in FIG. 8 may be implemented, in whole or in part, on system 100, system 200, system 400, system 600, and/or any other appropriately configured system architecture as described herein. For the avoidance of doubt, the term “control circuitry” used in the below description applies broadly to the control circuitry outlined above with reference to FIG. 1 and/or FIG. 2. For example, control circuitry may comprise control circuitry of user device 102 and control circuitry of server 104, working either alone or in some combination.

At 802, control circuitry, e.g., control circuitry of server 104, detects the presence of a first user within a local area network (LAN). As is described above, the detection of the presence of a first user may be based on a user device, facial recognition, the detection of an ID card corresponding to a user at a user terminal, and so on.

At 804, control circuitry, e.g., control circuitry of server 104, initiates a visit session. For example, the visit session may be initiated in response to detecting of the presence of the first user, in any of the manners described above.

At 806, control circuitry, e.g., control circuitry of server 104, generates multiple sound types at respective sound sources in the local area network. For example, different sound types, such as sound of different genres of music, different melodies, and so on, may be generated at different locations within a venue (or appear to a user to originate from different locations within a venue).

At 808, control circuitry, e.g., control circuitry of server 104, determines user reactions to the multiple sound types. For example, the user reactions to multiple sound types may be determined by generating a first sound type at a first (e.g., physical) sound source in the LAN during the visit session, generating a second sound type at a second (e.g., physical) sound source in the LAN during the visit session, and determining the user's reaction to each of the first and second sound sources. In some examples, the sound may be generated to appear to originate from virtual sound sources. For example, the user's reaction to different sounds may be tracked as a user enters a venue, such as a casino. The user's reaction may be gauged based on the user's apparent interest in the sound sources, for example, the user turning towards a particular sound source may indicate a preference of the user for the sound originating from that sound source.

At 810, a setting in a user profile is updated based on the user reactions. For example, the user's interest or disinterest in, or apparent preference or dislike for, particular sounds, may be stored as part of the user profile. The user profile may indicate various sounds in order of user preference, and/or may indicate a preferred sound or sound type.

Following 804, at 812, control circuitry, e.g., control circuitry of server 104, associates a user profile of the first user with the visit session, as described above.

At 814, control circuitry, e.g., control circuitry of server 104, determines an outcome of an event at a first user terminal. For example, the event may be a game, where the outcome of the event is either a win or a loss.

At 816, control circuitry, e.g., control circuitry of server 104, determines whether the outcome is below an outcome threshold. For example, where the event is a game, the outcome being below an outcome threshold may indicate a loss, and the outcome being above an outcome threshold may indicate a win. In some examples, the outcome threshold may be a winning score (e.g., in a video game) or a winning amount (e.g., in a casino). In the example of a multi-line slot machine in a casino, the outcome threshold may be set such that a loss might indicate a win. Additionally, or alternatively, the outcome threshold may be set such that a small win does not cause the outcome threshold to be breached. Additionally, or alternatively, the outcome may be subjective to the user. For example, the user may have the ability to override the outcome threshold and initiate a virtual sound source if the user thinks the notification of the win (or loss) is worth sharing with other users.

Where it is determined at 816 that the outcome is not below an outcome threshold (NO at 816, e.g., where the outcome is a win), at 824, control circuitry, e.g., control circuitry of server 104, generates a moving virtual sound source at the first user terminal. For example, the moving virtual sound source may be generated by modifying the output of each speaker in a speaker array, such as a speaker array of a terminal device currently used by the user, to generate the moving virtual sound source, where the output of the speaker may be dynamic such that the virtual sound source appears to the user to move. For example, it may appear to the user that the sound is being broadcast around the venue. Advantageously, while the sound appears to the user to be broadcast around the venue (and to other individuals), in reality, the sound may be generally localized to the current location of the user, where other individuals may be largely unable to hear the sound generated at the location of the user. Thus, other individuals may not be disturbed by the sound generated in the vicinity of the user.

Where it is determined at 816 that the outcome is below an outcome threshold (YES at 816), and following on from 810, at 818, control circuitry, e.g., control circuitry of server 104, accesses a setting in the user profile. The setting may be the setting updated at 810. The setting may be a setting indicating a preferred sound, or sound type, for the user.

At 820, control circuitry, e.g., control circuitry of server 104, selects a first sound type from the multiple sound types based on the user setting. For example, the sound type selected may be a sound type which is indicated in the user setting as being preferred by the user.

At 822, control circuitry, e.g., control circuitry of server 104, generates the selected sound type at a virtual sound source at a second user terminal. For example, the selected sound type may be generated at the virtual sound source. This may suggest to the user that the second user terminal is superior to the terminal they are currently using and may encourage the user to move to the second user terminal. Users can also request a change of user terminals (e.g., slot machines), in which case a virtual sound source at a second user terminal (i.e., a second slot machine) may be generated. In some embodiments, the virtual sound may be generated as the user is roaming (e.g., walking) the vicinity.

The actions or descriptions of FIG. 8 may be performed or executed in any suitable alternative orders or in parallel to further the purposes of this disclosure.

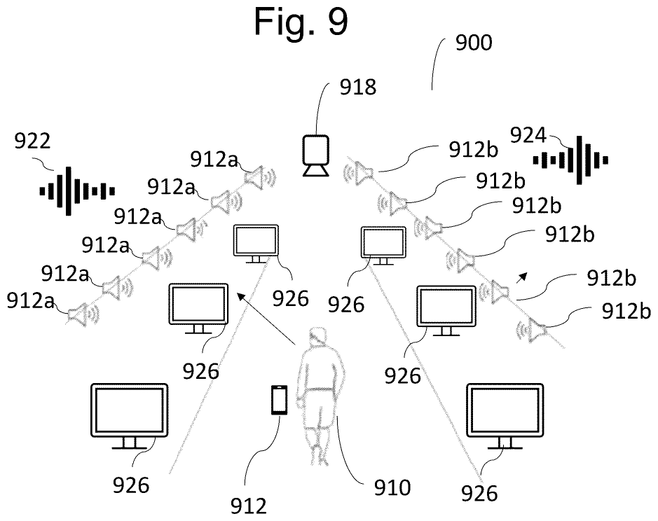

The below examples shown in FIGS. 9-11B illustrate various ways in which the processes illustrated in FIG. 8 may be implemented. In particular, the below examples make reference to assisting in the management of a user's location in an entertainment venue, such as a casino. However, it is to be understood that the present disclosure is not limited to such an example, and general process 300 may be implemented in a variety of situations, such as in any appropriate venue or location where assistance in the control of peoples' locations is desired, such as in hotels, malls, office buildings, etc.

FIG. 9 shows a system 900 for determining a sound type to be associated with a user account. In the example shown in FIG. 9, multiple speakers 912 are connected to a LAN (not shown) as described, for example, in relation to FIG. 1. In this example, the array of speakers 912 are arranged in two groups, one on either side of an aisle (in this example comprising a plurality of user terminals 926) through which a user 910 walks. A user device 912 associated with the user 910 is used in this example to identify the user. However, it will be appreciated that other methods such as facial recognition e.g., using the camera 918, may instead be used to identify the user. The system 900 further comprises a camera system comprising at least one camera 918 which monitors the user 910 as they pass down the aisle.

As the user 910 progresses down the aisle, a first group of the speakers 912a play a first sound type 922, and the second group of the speakers 912b play a second sound type 924. In this example, only two sound types are shown, however, it will be appreciated that any number of sound types may be played (e.g., by different speakers or groups of speakers). In accordance with the description above, the sound may be directed to the particular user, e.g., by beamforming, so that the sound effectively follows the user as they progress down the aisle, such that the sound is more audible to the user than to other individuals in the vicinity. In other examples, the sound may simply be generated at different locations within a venue. The different sound types may additionally be generated so as to seem to the user to originate in different (virtual) locations.

The camera 918 observes the user's reaction to the multiple sound types. From the observations, a server (not shown) may determine whether a user moves closer to the direction from which a particular sound type appears to originate, turns their head towards the direction from which a particular sound type appears to originate, and/or looks towards the direction from which a particular sound type appears to originate (by head movement and/or eye movement). The server may determine the user's reaction (e.g., a positive or negative reaction, or emotional reaction) to particular sounds, e.g., based on facial expressions of the user. The system 900 may assume that a user's movement towards a particular sound indicates a preference of the user for that sound and/or a user's facial expression when turning towards a particular sound may be used to determine approval or disapproval of the sound. Settings in a user profile associated with the user may be updated based on the user's reaction to the sounds. For example, the sound that the user has the most positive reaction towards, e.g., by movement towards the sound, and/or a facial expression, may be indicated in the user profile as being a positive sound for the user, or may be set as the default sound for a user. The different sounds may be ranked based on the user's reaction to each sound within the profile.

FIG. 10 shows a system for generating a predetermined sound type at a remote location using a virtual sound source. In the example shown in FIG. 10, a first user terminal 1026 (e.g., a gaming device) currently associated with a user 1010 (e.g., based on a determined proximity of the user to the user terminal, such as based on a user device such as a mobile phone, facial recognition processes, or in this example, a user device in the form of a card 1028 such as a loyalty card or login card, which may be NFC readable, used in conjunction with the user terminal 1026) comprises a speaker array comprising a plurality of speakers 1012. In this example, the first user terminal 1026 is connected to a LAN such those described above. The first user terminal 1026 may receive via the LAN information relating to a user profile of the user 1010, where the user has been identified by use of their card 1028 with the first user terminal 1026. The user profile may indicate particular sounds that are preferential to the user, as is described above. Where the user terminals are gaming devices, and the user is not achieving a win at their current user terminal (e.g., the outcome of an event such as a game at the first user terminal is below an outcome threshold), the first user terminal 1026 may be configured to cause a preferential sound type to be output from the speaker array, where the sound may appear to the user to originate from a virtual sound source, which in this example is shown as a second user terminal 1030. The generation of the sound may be made in response to an elapsed period, for example, after a predetermined amount of time that the user has been interacting with the first user terminal and has not achieved a win.

Where the first user terminal 1026 and the second user terminal 1030 are gaming devices, the generated sound may suggest to the user that another player at a different machine is having more success using the second user terminal 1030. This may encourage the user to leave the first user terminal 1026 and move to a different user terminal (e.g., the second user terminal 1030).

In further examples, such as where the user terminal is a self-checkout device, where an error occurs during a shopping transaction of the user (e.g., this error may be regarded as an outcome below an outcome threshold), the generated sound may appear to the user to be generated in the vicinity of a member of staff, in order to alert the member of staff to the issue at the user terminal (although the sound may only be audible to the user). The member of staff may be alerted in a way that does not disturb other customers, such as via an alert device which vibrates when a customer has an issue with a self-checkout device. Additionally, or alternatively, the generated sound may appear to the user to be generated in the vicinity of a different, functioning self-checkout device, e.g., to inform the user to of an alternative self-checkout device on which they may progress their transaction.

FIGS. 11A and 11B show a system 1100 for generating a moving virtual sound source. The example shown in FIG. 11 illustrates the first user terminal 1126 as described above in relation to FIG. 10. However, in this example, where the first user terminal 1126 is a gaming device, in this example, the user 1110 achieves a win at their current user terminal (e.g., the outcome of an event such as a game at the first user terminal 1126 is above an outcome threshold). In response to a positive or successful outcome for the user 1110, the sound type preferred by the user 1110 (e.g., determined based on the setting of the user profile) is output by the speaker array 1112 of the first user terminal 1126, where the sound may appear to the user to originate from a virtual sound source. In this example, the virtual sound 1120 appears to the user to move around the venue, such that the sound appears to be effectively broadcast to any other individuals in the vicinity.

In the examples of FIG. 10 and FIGS. 11A and 11B, to direct the produced sound to the user, the movement of a user's head may be tracked, for example, using a camera provided in the user terminal and/or associated with the LAN. This may enable more accurate beamforming of the sound (e.g., directed towards the actual position of the user's head or ears). Thus, the sound may be effectively isolated so that it is substantially only audible for the user to whom it is directed.

In some examples, a sound type corresponding to the user profile (e.g., a sound type determined to be preferred by a user) may be played at various locations within the LAN and/or in response to various actions of the user. For example, when a user reaches their floor in an elevator, the sound may play, when a user is served in a café or restaurant, the sound may play, and so on. The use of the sound in scenarios which are positive experiences for the user may serve to reinforce the user's enjoyment of the sound.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method for managing user location using a virtual sound source, the method comprising:
detecting, using control circuitry, the presence of a first user within a local area network;
initiating, using control circuitry, a visit session in response to detecting the presence of the first user;
determining, using control circuitry, a location of the first user within the local area network during the visit session; and
modifying, using control circuitry, an output of one or more speakers to generate a virtual sound source at a remote location within the local area network away from the location of the first user.

2. The method of claim 1, the method comprising:
detecting the presence of a second user within the local network area during the visit session;
associating the second user with the visit session;
determining a location of the second user within the local area network during the visit session, wherein the location of the second user corresponds to the remote location at which the virtual sound source is generated.

3. The method of claim 2, the method comprising:
assigning, to the visit session, a first user device associated with the first user, wherein the location of the first user is based on the location of the first user device; and
assigning, to the visit session, a second user device associated with the second user, wherein the location of the second user is based on the location of the second user device.

4. The method of claim 1, the method comprising:
determining a density of individuals at the location of the first user; and
modifying the output of a speaker to generate the virtual sound source at the remote location when the density of individuals at the location of the first user is greater than a predetermined density value.

5. The method of claim 1, the method comprising:
determining a density of individuals at the remote location; and
modifying the output of a speaker to generate the virtual sound source at the remote location when the density of individuals at the remote location is less than a predetermined density value.

6. The method of claim 1, the method comprising:
associating a user profile of the first user with the visit session;
accessing a setting in the user profile; and
generating a first sound type at the virtual sound source based on the setting.

7. The method of claim 6, the method comprising:
determining a user reaction to multiple sounds types; and
updating the setting in the user profile based on the user reaction.

8. The method of claim 7, wherein determining the user reaction to multiple sounds types comprises:
generating a first sound type at a first sound source in the local area network during the visit session;
generating a second sound type at a second sound source in the local area network during the visit session; and
determining a user reaction to each of the first and second sound sources.

9. The method of claim 1, wherein the one or more speakers are located at a first user terminal on the local area network, and wherein the remote location corresponds to a location of a second user terminal on the local area network.

10. The method of claim 1, wherein the one or more speakers the first user terminal comprises a speaker array, the method comprising:
determining an outcome of an event at the first user terminal; and
generating, based on the outcome of the event, a moving virtual sound source by modifying, in turn, an output of each of the speakers in the array to generate the virtual sound source.

11. A system for managing user location using a virtual sound source comprising control circuitry configured to:
detect the presence of a first user within a local area network;
initiate a visit session in response to detecting the presence of the first user;
determine a location of the first user within the local area network during the visit session; and
modify an output of one or more speakers to generate a virtual sound source at a remote location within the local area network away from the location of the first user.

12. The system of claim 11, wherein the control circuitry is configured to:
detect the presence of a second user within the local network area during the visit session;
associate the second user with the visit session;
determine a location of the second user within the local area network during the visit session, wherein the location of the second user corresponds to the remote location at which the virtual sound source is generated.

13. The system of claim 12, wherein the control circuitry is configured to:
assign, to the visit session, a first user device associated with the first user, wherein the location of the first user is based on the location of the first user device; and
assign, to the visit session, a second user device associated with the second user, wherein the location of the second user is based on the location of the second user device.

14. The system of claim 11, wherein the control circuitry is configured to:
determine a density of individuals at the location of the first user; and
modify the output of a speaker to generate the virtual sound source at the remote location when the density of individuals at the location of the first user is greater than a predetermined density value.

15. The system of claim 11, wherein the control circuitry is configured to:
determine a density of individuals at the remote location; and
modify the output of a speaker to generate the virtual sound source at the remote location when the density of individuals at the remote location is less than a predetermined density value.

16. The system of claim 11, wherein the control circuitry is configured to:
associate a user profile of the first user with the visit session;
access a setting in the user profile; and
generate a first sound type at the virtual sound source based on the setting.

17. The system of claim 16, wherein the control circuitry is configured to:
determine a user reaction to multiple sounds types; and
update the setting in the user profile based on the user reaction.

18. The system of claim 17, wherein determining the user reaction to multiple sounds types comprises:
generating a first sound type at a first sound source in the local area network during the visit session;
generating a second sound type at a second sound source in the local area network during the visit session; and
determining a user reaction to each of the first and second sound sources.

19. The system of claim 11, wherein the one or more speakers are located at a first user terminal on the local area network, and wherein the remote location corresponds to a location of a second user terminal on the local area network.

20. The system of claim 11, wherein the one or more speakers of the first user terminal comprises a speaker array, and wherein the control circuitry is configured to:
determine an outcome of an event at the first user terminal; and
generate, based on the outcome of the event, a moving virtual sound source by modifying, in turn, an output of each of the speakers in the array to generate the virtual sound source.

21-50. (canceled)
